(19) United States
(12) Patent Application Publication
(10) Pub. No.: US 2024/0269030 A1
(43) Pub. Date: Aug. 15, 2024

(54) Spinal Support Device and Methods of Use

(71) Applicant: CONTOUREAL, LLC, Portland, OR (US)

(72) Inventor: Parviz Jahangiri, Portland, OR (US)

(73) Assignee: CONTOUREAL, LLC, Portland, OR (US)

(21) Appl. No.: 18/107,723

(22) Filed: Feb. 9, 2023

(51) Int. Cl. A61H 1/02

(52) U.S. Cl. CPC A61H 1/0292

(57) ABSTRACT

Spinal support devices and methods of use. Support devices have a base unit, a face support unit defining a first end, a pelvic support unit defining a second end, and a chest support unit positioned between said face and pelvic support units, wherein the chest and pelvic support units each have a convex shaped topside that is configured to align within designated concave shaped areas on the user's frontside when they lie on device in a prone position.

### BACKGROUND OF THE INVENTION

Spinal pain and abnormal curvature are common and difficult problems for many people. These often result from significant and/or prolonged stress from the body simply supporting itself under normal conditions, physical exercise, or improper posture while sitting or standing.

Accordingly, there is a need in the art for a portable spinal support device designed for a particular user's anatomy and spinal issues that can help prevent or treat spinal malformities to either maintain or restore normal spinal curvature. People having significantly different anatomies or spinal misalignments should have access to different spinal support devices configured or otherwise customized to be used with their specific characteristics. Preferred spinal support devices should have the ability to both provide axial compressive load to the vertebrae to stimulate bone growth and induce corrective spinal curvature from the lordotic neck curvature to the sacral curvature while the user is in a prone position.

### SUMMARY OF THE INVENTION

Preferred embodiments are directed to methods of using a spinal support device on a human comprising providing a spinal support device comprising a base unit having a longitudinal axis along first and second ends, and having a face support unit defining the first end, a pelvic support unit defining the second end, and a chest support unit positioned between said face and pelvic support units, wherein the pelvic and chest support units each have a convex shaped topside with an apex; and positioning the person on the device in a prone position, wherein the face of the person is positioned on the face support unit, the apex of the chest support unit supports the center, or within 0.5 inches up or down therefrom, of the disc between the T6 and T7 vertebrae, and the apex of the pelvic support unit supports a position on the spine from the L5 vertebra to 1 inch down from the top of the sacrum.

Preferred embodiments are directed to methods wherein the face support unit is configured to be slidable and releasably lockable along the longitudinal axis of the base unit both towards and away from the chest support unit so as to form a first gap from the face support unit and the chest support unit; and wherein the pelvic support unit is configured to be slidable and releasably lockable along the longitudinal axis of the base unit both towards and away from the chest support unit so as to form a second gap between the pelvic support unit and the chest support unit.

Preferred embodiments are directed to methods further comprising measuring the length of a predetermined span of the human's spine and adjusting the face and pelvic support units either closer to or away from the chest support unit based on the measured length, wherein, for a first person having a longer measurement than a second person, the face and pelvic support units are moved away from the chest support unit for the first person and moved closer to the chest support unit for the second person.

Preferred embodiments are directed to methods wherein when the pelvic support and the face supports are moved away from the chest support and releasably locked, the second gap between the pelvic support unit and the chest support unit is longer in length than the first gap between the face support unit and the chest support unit.

Preferred embodiments are directed to methods wherein the length of the second gap is between 2.0 to 2.5 times greater than the length of the first gap.

Preferred embodiments are directed to methods wherein the length of the second gap is 2.25 times greater than the length of the first gap.

Preferred embodiments are directed to methods wherein intermittent locking points are set between: a) the face support unit and chest support unit, and b) the pelvic support unit and the chest support unit, such that the face and pelvic support units are releasably lockable at these points along the longitudinal axis and correspond to preset measured lengths of the predetermined span of the human's spine.

Preferred embodiments are directed to methods wherein the predetermined span of the human's spine that is measured is the distance from the top of the T1 vertebra to the bottom of the sacrum.

Preferred embodiments are directed to methods wherein the predetermined span is measured by having the user sit upright on a surface and measuring the distance from the T1 vertebra and the surface.

Preferred embodiments are directed to methods wherein when the predetermined length of the human spine is 23″ or less, the neck and upper thigh support units are adjacent to the mid-back support such that no first or second gaps exists.

Preferred embodiments are directed to methods wherein when the length of the human spine is between 23″ to 25″, the first gap is between 0 to 0.5 inches and the second gap is between 2.0 to 2.5 times greater than the length of the first gap.

Preferred embodiments are directed to methods wherein when the length of the human spine is between 25″ to 27″, the first gap is between 0.5 to 1 inches and the second gap is between 2.0 to 2.5 times greater than the length of the first gap.

Preferred embodiments are directed to methods wherein when the length of the human spine is between 27″ to 29″, the first gap is between 1 to 1.5 inches and the second gap is between 2.0 to 2.5 times greater than the length of the first gap.

Preferred embodiments are directed to methods wherein when the length of the human spine is between 29″ to 31″, the first gap is between 1.5 to 2 inches and the second gap is between 2.0 to 2.5 times greater than the length of the first gap.

Preferred embodiments are directed to methods wherein when the length of the human spine is between 31″ to 33″, the first gap is between 2 to 2.5 inches and the second gap is between 2.0 to 2.5 times greater than the length of the first gap.

Preferred embodiments are directed to methods wherein the face, pelvic, and chest support units are not slidable along the longitudinal axis on the base, such that they are fixed in place.

Preferred embodiments are directed to methods further comprising measuring the length of a predetermined span of the human's spine and selecting the spinal support device from first and second spinal support devices, each having differently sized fixed distances between the chest support unit and the face and pelvic support unit, based on said measurement.

Preferred embodiments are directed to methods wherein the convex shaped topside of the pelvic support unit comprises two convex shaped topsides that converge towards the second end at an angle from 30-60 degrees.

Preferred embodiments are directed to methods wherein the chest support unit comprises two shoulder rests that support the persons shoulders while lying on the device.

Preferred embodiments are directed to methods wherein the converging convex shaped topsides and/or the shoulder rests are adjustable such that the angle of the converging convex shaped topsides or the distance between the shoulder rests can be increased or decreased.

### BRIEF DESCRIPTION OF DRAWINGS

FIG. 1 is an exploded, perspective view of a spinal support device.

FIG. 2 is an assembled perspective view of a spinal support device.

FIG. 3 is an exploded, topside view of a spinal support device.

FIG. 4 is an assembled, topside view of a spinal support device.

FIG. 5 is an assembled, left-side view of a spinal support device.

FIG. 6 is an assembled, left-side view of a spinal support device with a user in a prone position.

FIG. 7 is a perspective view of an alternative pelvic support device.

FIG. 8 is a drawing of a spine showing transition points of curvature.

### DETAILED DESCRIPTION OF THE INVENTION

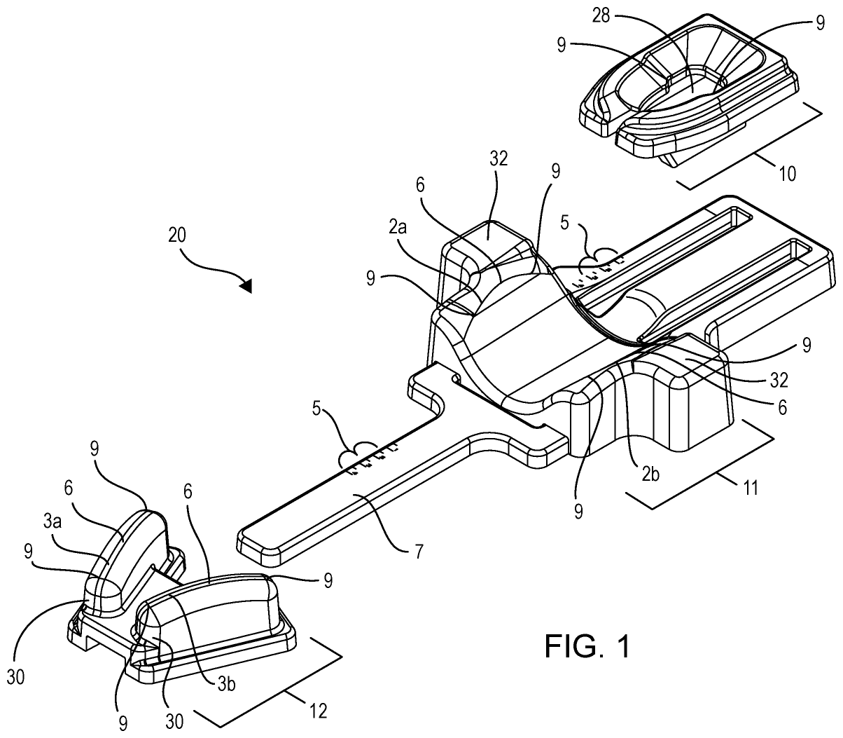

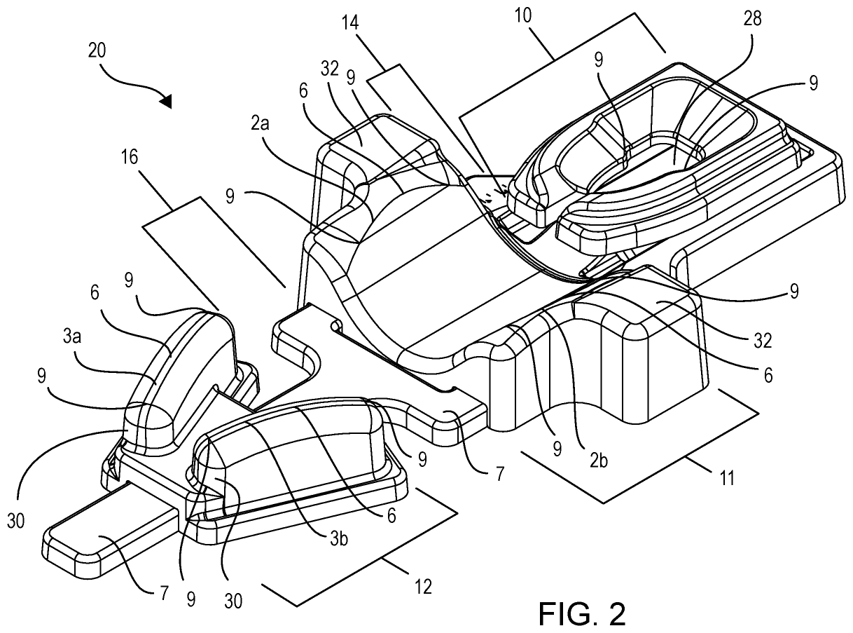

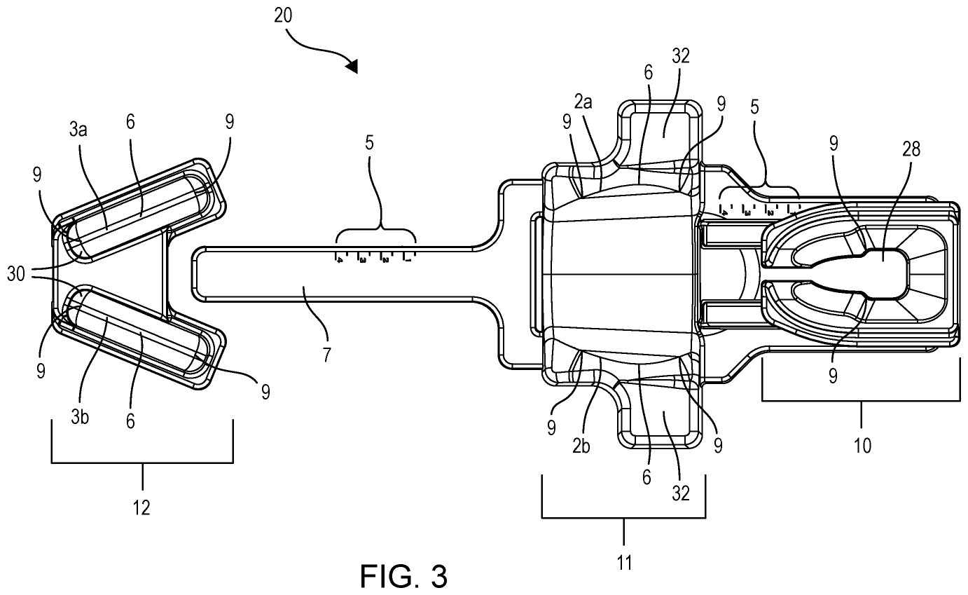

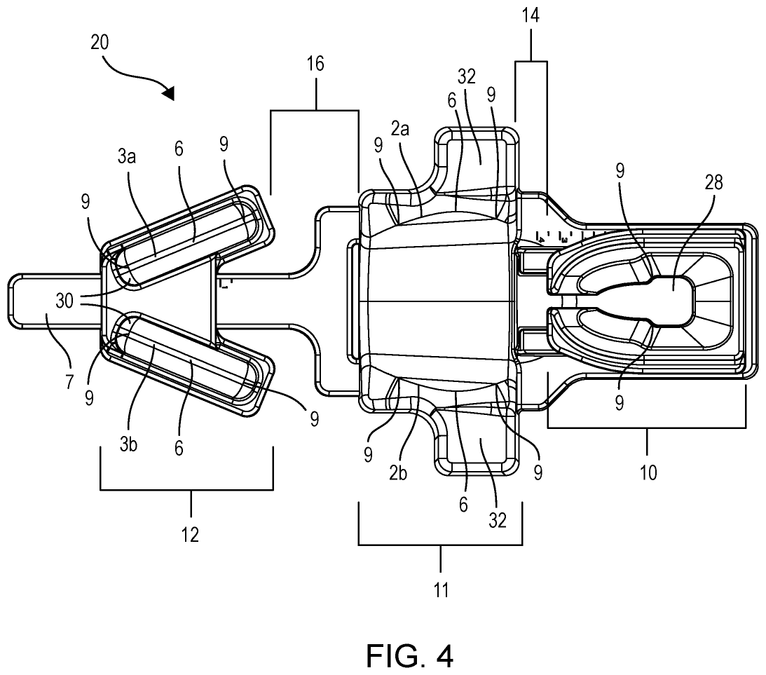

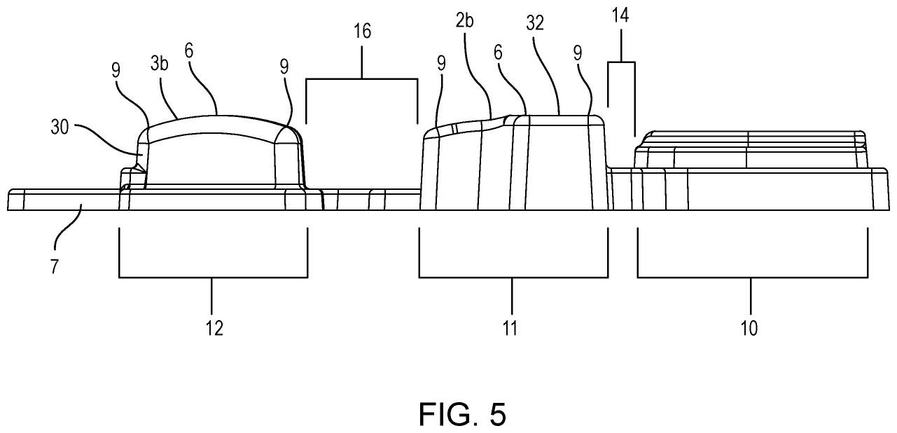

As shown in FIGS. 1-6, preferred spinal support devices 20 for methods of use described herein comprise a base unit 7 having a longitudinal axis along first and second ends, and three support units: a face support unit (FSU) 10, a chest support unit (CSU) 11 and a pelvic support unit (PSU) 12. Preferably the FSU 10 is positioned at the first end of the base 7, the PSU 12 is positioned at the second, opposite end of the base 7, and the CSU 11 is positioned between the FSU 10 and the PSU 12, in the center of the base 7. While shown in FIGS. 2, 4, 5, and 6 as extending past the FSU 10 and PSU 12, the base 7 can terminate within the FSU 10 and the PSU 12, according to other embodiments. Regardless of its termination points, it is preferred that the PSU 12 and the FSU 10 are the last support units on the base 7, such that there are no further support units positioned past them towards the first and second ends of the base 7 on the longitudinal axis. It is further preferred that there are only three support units (10, 11, 12) total on the base 7.

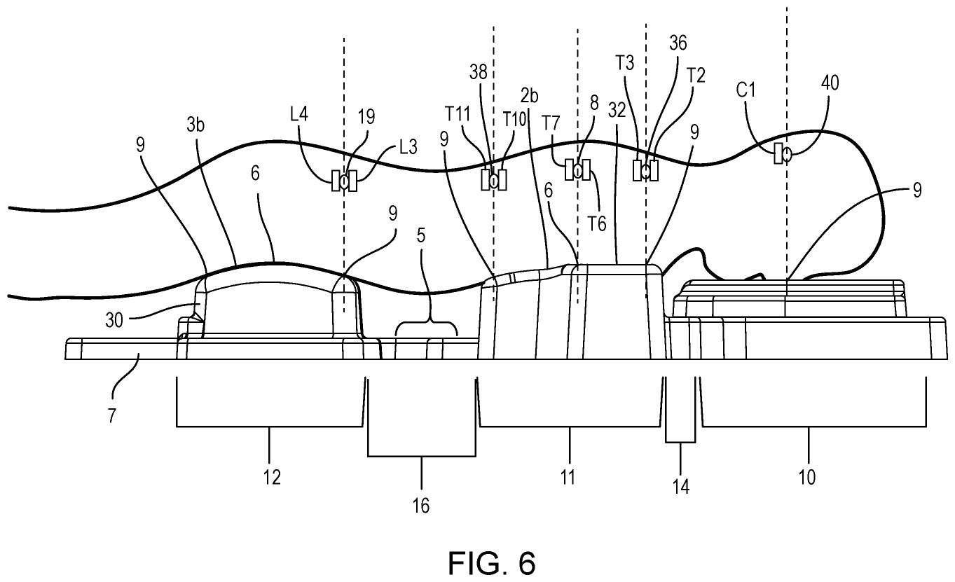

The FSU 10 is configured to comfortably support a user's face while lying on the device 20 in a prone position, such as shown in FIG. 6. Accordingly, the FSU 10 preferably has a recess 28 and/or hole so the user's face cannot be unnecessarily pressed against a convex, flat, or raised surface.

Preferably the base 7 is made of sturdy rigid, or semi-rigid material such as metal (e.g., steel, aluminum, or alloy), hard plastic, polyurethane, or carbon, such that it can support the user, and act as a track for embodiments covering sliding FSU 10 and PSU 12. The underside of the base 7 is preferably planar, but can also have support legs and/or caster wheels, for example. According to certain embodiments, support legs can be adjustable to create customized heights of the device 20. According to further embodiments, the base 7 can be configured to lengthen or widen, such as through the utilization of a telescoping mechanism and/or extensions.

It is preferred that the CSU and PSU (11, 12) have a convex shaped topside with an apex 6. While the convex shaped topside can be a singular feature (not shown), it is preferred that the convex shaped topside of the CSU and PSU (11, 12) comprise two convex shaped topsides separated from each other. More specifically, it is preferred that the CSU 11 comprises two substantially parallel convex shaped topsides 2a/2b. 2a/2b can also converge or diverge. The two convex shaped topsides 2a/2b on the CSU 11 are configured to support the sides of a user's ribcage or ribs that correspond to the user's chest and upper back area, from the T3 to the T10 vertebrae. The CSU 11 preferably has shoulder rests 32 that are configured to support a user's shoulders when laying on the device 20 in a prone position. According to certain embodiments, the CSU 11 has an apex 6 that is positioned equidistant between the two inflection points 9, which are preferably the lowest points of the convex shaped topsides 2a/2b, or the lowest points of the curve.

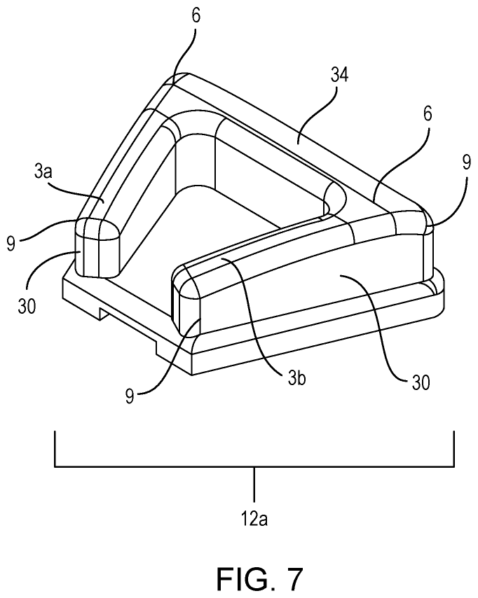

While they can also be parallel, it is preferred that the PSU 12 comprises two risers 30 each having convex shaped topsides 3a/3b that converge towards the second end of the device 20. More specifically, it is preferred that the two convex shaped topsides 3a/3b that converge at an angle from 30-60 degrees, and more specifically 45 degrees +/−5 degrees. As shown in FIGS. 1-6, the converging risers 30 can be disconnected, but alternatively, and as shown in the PSU 12a of FIG. 7, the risers 30 can be connected by another cross-riser 34 positioned on the non-converging side of the PSU 12a (the side of the PSU 12a closest to the CSU 11). According to certain embodiments, either the PSU 12 or the PSU 12a has an apex 6 that is not positioned equidistant between the two inflection points 9, which are the lowest points on the convex shaped topsides 3a/3b. Regardless of the position of the apex 6, when the device 20 is properly used, the inflection points 9 on the PSU 12 closest to the CSU 11, will be aligned on the transverse plane with the center, or within 0.5 inches up or down, of the disc 19 between the L3 and L4 vertebrae. As shown in FIG. 6, when the apex 6 of the PSU 12 is in the center of the two convex shaped topsides 3a/3b, equidistant from its respective two inflection points 9, the apex 6 is preferably aligned on the transverse plane on the sacrum, within 1 inch down from the top of the sacrum. When the apex 6 of the PSU 12a is not positioned equidistant between the two inflection points 9, such as shown in FIG. 7, the apex 6 is preferably aligned on the transverse plane with the disc between the L5-S1, or within 0.5 inches up or down thereof.

As different users have different spinal configurations and/or malformities, it is preferred that the right and left convex shaped topsides 2a/2b and 3a/3b are configured be adjustable. According to certain embodiments, the shoulder rests 32 and/or convex shaped topsides 2a/2b on the CSU 11 can be configured to be adjustable such that the distance between them and/or their height can be increased or decreased. According to certain embodiments, the convex shaped topsides 3a/3b on the PSU 12 can be configured to be adjustable such that the angle between them and/or their height can be increased or decreased. These adjustments can be made utilizing any suitable mechanism, such as by decreasing and increasing the width of the right and left convex shaped topsides 2a/2b and/or 3a/3b and/or shoulder rests 32. Additionally, a telescoping mechanism, sliding track, and/or extensions can be used. Similarly, the height of the right and left convex shaped topsides 2a/2b and/or 3a/3b and/or shoulder rests 32 can be increased and decreased utilizing any suitable mechanism, such as by increasing and decreasing or the height of the right and left convex shaped topsides 2a/2b and/or 3a/3b, and/or shoulder rests 32 respectively. Additionally, a telescoping mechanism, sliding track, and/or extensions can be used.

The right and left convex shaped topsides 2a/2b and/or 3a/3b can be permanently fixed to the CSU 11 and PSU 12 respectively or can be detachable. According to certain embodiments, a plurality of different sized right and left convex shaped topsides 2a/2b and/or 3a/3b can be provided and selected based on a particular patient's anatomy. Additionally, the right and left convex shaped topsides 2a/2b and/or 3a/3b can be modular wherein layers can be added or removed to achieve different heights and widths. While the shoulder rest 32 may have a higher top than the convex shaped topsides 2a/2b, the designated apex 6 of the CSU 11 is positioned on the convex shaped topsides 2a/2b as shown in FIGS. 1-6. For certain embodiments the apex 6 is the highest point on the CSU and/or PSU (11, 12).

It is preferred that each of the support units (10, 11, 12) are made of a rigid or semi-rigid material suitable for supporting the user in a prone position, such as plastic, wood, composite wood, metal, and foam. Additional flexible material, including foams, rubber, or other cushioning can be used for comfort. Additionally, each of the support units (10, 11, 12) can be made of multiple materials or a singular material such as polyurethane.

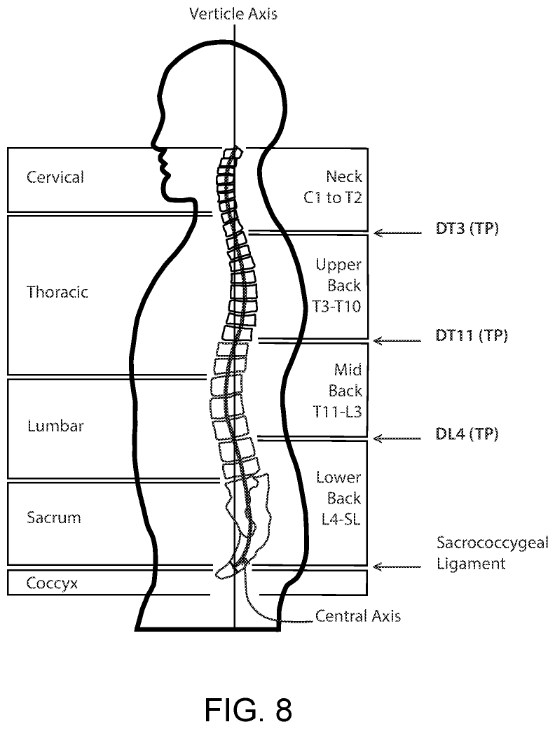

Transition points are points along the spinal column where spinal vertebrates changes in lining up from a concave shape to a convex shape. These transition points largely coincide with a vertical line (Vertical Axis), drawn between the top vertebrate to the tail bone, and a central line (Central Axis) that connects to the central axis of each vertebrate. Preferably these transition points should ideally be supported or controlled so that they relatively align in a straight line. Transitions points also coincide with traverse features on the body such as the nose, the sternomanubrial joint, the xiphisternal joint, the navel, and the hip joints respectively. FIG. 8 shows a human spine with the following transition points: DC1, DT3, DT11, DL4 and the sacrococcygeal ligament. In general, and as shown in FIG. 8, normal humans comprise two concave sections on the frontside of their spine: 1) the chest from (+/−0.5 inches) DT3 to DT11 and 2) the pelvis from (+/−0.5 inches) DL4 to the sacrococcygeal ligament that the CSU 11 and the PSU 12 are configured to support respectively. More specifically, according to preferred embodiments, these concave sections of the chest and pelvis align with the convex shaped topsides 2a/2b, and 3a/3b when a patient is lying on the device 20 in a prone position. It is preferred that the inflection points 9 on the support units (11, 12) align with their respective transition points on the spine along the traverse plane, when the user is on the device 20 in a prone position, as shown in FIG. 6. Preferably the FSU 10 includes an inflection point 9, that is positioned in the middle of the FSU 10 recess 28 along the longitudinal axis and is aligned on the traverse plane with the disc 40 above the C1 vertebra. According to preferred embodiments, the inflection points 9 on CSU and PSU (11 and 12) represent the low ends of a convex shaped topsides 2a/2b, and 3a/3b. As used herein the term convex and concave can signify any curve, including the arc of a circle, oval, ellipse, and thus does not need to (but can) represent a parabola.

Preferred CSU and PSU (11, 12) comprise two inflection points 9 that are equidistant from a center apex 6 of each the convex shaped topsides 2a/2b, and 3a/3b. According to certain embodiments, apexes 6 of the PSU or CSU are not positioned equidistant between the two inflection points 9. By aligning the apexes 6 (whether centered or not) of the support units (11, 12), to their respective center of the spine's concave section being supported, the convex shaped topsides 2a/2b, and 3a/3b automatically conform to the user's spine. Preferably, each inflection point 9 on each support unit (11, 12), can change distance, symmetrically, based on the user's spinal size and shape, keeping the center apex 6 of each support unit (11, 12) aligned on the transverse plane with the user's respective centers of their two concave sections. According to more specific and/or alternative embodiments, the inflection points 9 preferably align on the transverse plane with their designated transition points on the spine.

As shown in FIG. 6, when a human user is positioned on the device 20 in a prone position, the CSU 11 generally supports the spine from the T3 to the T10 vertebrae (+/−0.5 inches), with the apex 6 of the CSU 11 supporting the center, or within 0.5 inches up or down, of the disc 8 between the T6 and T7 vertebrae. The topside 2a/2b inflection points 9 on the CSU 11 closest to the FSU 10 are preferably aligned on the transverse plane with the transition point of the disc 36 between the T2 and T3 vertebrae, or within 0.5 inches up or down thereof. The topside 2a/2b inflection points 9 on the CSU 11 closest to the PSU 12 are preferably aligned on the transverse plane with the transition point of the disc 38 between the T10 and T11 vertebrae, or within 0.5 inches up or down thereof. The PSU 12 generally supports the spine from the L4 vertebra to the Sacrococcygeal ligament (SL). When aligned properly, the topside 3a/3b inflection points 9 of the PSU 12 closest to the CSU 11, will be aligned on the transverse plane with the center, or within 0.5 inches up or down, of the disc 19 between the L3 and L4 vertebrae. When the apexes 6 of the PSU 12 are positioned in the center of the two convex shaped topsides 3a/3b, equidistant from their respective two inflection points 9 and as shown in FIG. 6, they are preferably aligned on the transverse plane on the sacrum, preferably within 1 inch down from the top of the sacrum. As shown in FIG. 7, when the apexes 6 of the PSU 12 are not positioned in the center of the two convex shaped topsides 3a/3b, and are not equidistant from their respective two inflection points 9, they are preferably aligned on the transverse plane within 0.5 inches of the L5-S1 disc. This point corresponds generally to the hip joint. Adjustments can be made for larger or smaller spines.

The spinal support devices 20 and methods of use described herein can be used to prevent or treat spinal misalignments by maintaining or helping restore normal curvature in the spine. According to preferred embodiments, the spinal support devices 20 described herein can accommodate different users having different anatomies, non-exclusively including different spinal curvatures, spinal malformities such as kyphosis, lordosis, scoliosis, different lengths of spine, and different transition points within the spine.

Accommodating individualized users having separate anatomies from each other can be accomplished by the following three preferred embodiments, for example.

The first embodiment of accommodating individualized users having different anatomies is to provide a single adjustable device 20 that can be used with each different user. According to this method, the FSU 10 and/or the PSU 12 are configured to be movable such as to be positioned and releasably locked closer to or further away from the CSU 11. The CSU 11 is preferably fixed in place in the center of the longitudinal axis of the base 7 but can also be configured to be movable and releasably locked along the base 7. As described in more detail below, the FSU 10 and the PSU 12 are preferably configured to slide along the longitudinal axis of the base 7 which thus acts as a track. Preferably, the FSU 10 and the PSU 12 have a recessed section on their underside with lips/tabs to prevent their lateral dislodgement from the base 7. Alternatively, the FSU 10 and the PSU 12 can utilize a hollowed channel within to remain on the base 7 and prevent their lateral dislodgement therefrom. According to non-preferred embodiments not shown, the FSU 10 and the PSU 12 can be moved towards and away from the CSU 11 using a telescoping mechanism and/or extensions.

As shown in FIGS. 1-6, as the FSU 10 moves farther away along the base 7 from the CSU 11, the gap 14 between the CSU 11 and the FSU 10 increases in length. Conversely, as the FSU 10 moves closer along the base 7 towards the CSU 11, the gap 14 between the CSU 11 and the FSU 10 decreases in length. Similarly, as the PSU 12 moves farther away along the base 7 from the CSU 11, the gap 16 between the PSU 12 and the CSU 11 increases in length. Conversely, as the PSU 12 moves closer along the base 7 towards the CSU 11, the gap 16 between the CSU 11 and the PSU 12 decreases in length.

One preferred embodiment involves the use of intermittent locking points 5 that are set on the track 7 between the CSU 11 and the FSU 10 and/or between the CSU 11 and the PSU 12, such that the movable PSU 12 and the FSU 10 are releasably lockable at these points 5 along the longitudinal axis. Preferably, and as discussed in detail below, these locking points 5 correspond to preset measured lengths of a predetermined span of the human's spine. Alternatively, and not shown, the movable PSU 12 and the FSU 10 can be releasably locked continuously along the longitudinal axis of the track 7 without designated intermittent locking points. Regardless of whether intermittent or continuous releasable locking is utilized, any feasible releasable locking mechanisms can be used, including tabs, recesses, springs, clamps, and the like. Additional features that could optionally be adjustable non-exclusively include the width and height of the the support units (10, 11, 12) and more specifically, the height of the apex 6 of the CSU and PSU (11, 12), and the distance between inflection points 9 on the convex shaped topsides 2a/2b and 3a/3b. Alternatively, a non-preferred embodiment would be where only one support unit selected from the FSU 10 or the PSU 12 is adjustable along the track 7, and the other is in a fixed position.

The second embodiment of accommodating individualized users is to provide a plurality of different sized, yet adjustable devices 20. Under this non-preferred embodiment, one or more of the FSU 10, the CSU 11, and the PSU 12 can be slidable along the longitudinal axis on the base 7, such that they are not fixed in place. The plurality of different sized adjustable devices 20 can include a variety of adjustable or non-adjustable differences between them, non-exclusively including overall length of device 20, length of the track 7, the length of the gap (14 and 16) between the CSU 11 and the FSU 10 and between the CSU 11 and the PSU 12, the width or height of the support units (10, 11, 12), the height of the apex 6 of the CSU and PSU (11, 12), and the distance between inflection points 9 on the convex shaped topsides 2a/2b, and 3a/3b. When practicing this second embodiment of accommodation, it is advantageous to make one or more measurements on the human, non-exclusively including a length of a predetermined span of the human's spine, overall height, and/or curvature types, and then select a particularly sized spinal support device from the plurality of differently sized yet adjustable spinal support devices, that corresponds to said one or more measurements.

The third embodiment of accommodating individualized users is to provide a plurality of different sized non-adjustable devices 20. Under this non-preferred embodiment, the support units (10, 11, 12) are not slidable along the longitudinal axis on the base 7, such that they are fixed in place. The plurality of different sized non-adjustable devices 20 can include a variety of differences between them, non-exclusively including overall length of device 20, length of the track 7, the length of the gap (14 and 16) between the CSU 11 and the FSU 10 and between the CSU 11 and the PSU 12, the width or height of the support units (10, 11, 12), the height of the apex 6 of the CSU and PSU (11, 12), and the distance between inflection points 9 on the convex shaped topsides 2a/2b and 3a/3b on the CSU and PSU (11, 12). When practicing this third embodiment of accommodation, it is advantageous to make one or more measurements on the human, non-exclusively including a length of a predetermined span of the human's spine, overall height, and/or curvature, and then select a particularly sized spinal support device from the plurality of differently sized spinal support devices, that corresponds to said one or more measurements.

According to the first and second methods of adjustable accommodation described above, preferred methods involve measuring the length of a predetermined span of the human's spine and then adjusting the FSU 10 and/or the PSU 12 either closer to or away from the CSU 11 based on this measured length. As an example, for a first person having a significantly longer measurement than a second person, the FSU 10 and/or the PSU 12 are moved away from the CSU 11 and releasably locked, thereby increasing the distance of gaps 14 and 16 for the first person. Conversely, the FSU 10 and/or the PSU 12 are moved closer to the CSU 11 and releasably locked for the second person thereby decreasing the distance of the gaps 14 and 16. For the embodiments of measuring the length of a predetermined span of the human's spine, adjustments can be made for various conditions, non-exclusively including those suffering from abnormal spinal curvatures, abnormal disc sizes, and temporal conditions such as when they woke up from sleep, based on the degree of offset of said characteristic. For example, if a normal curvature span measurement of 27 inches corresponds to a particular configuration of the support units (10, 11, and 12), a person suffering from lordosis or kyphosis having a 30-inch measurement might utilize the same configuration of support units (10, 11, and 12) if there is a 3-inch offset.

According to preferred embodiments, when the PSU 12 and the FSU 10 are moved away from the CSU 11 and releasably locked, the second gap 16 between the PSU 12 and the CSU 11 is longer in length than the first gap 14 between the FSU 10 and the CSU 11. According to non-exclusive embodiments, the length of the second gap 16 is between 2 to 2.5 times greater than the length of the first gap 14, including 2.25 times greater than the length of the first gap 14.

The following are preferred, yet non-exclusive, methods of measuring a particular person and then adjusting the spinal support device 20 based on said measurement. The methods of measurement, but not adjustment, are applicable to the third embodiment of accommodation which would instead involve selecting one of a plurality of different non-adjustable devices. The predetermined span of the human's spine that is measured can be the distance from the top of the T1 vertebra to the bottom of the sacrum. This span can be measured in any suitable way, including when the user is standing up, however can easily be done by having the user sit upright on a surface, such as the floor, mat, chair, or stool, and then measuring the distance from the top of the T1 vertebra to the surface (e.g., the floor, the mat, the seat of the chair, or seat of the stool).

Table 1 below lists a column of distances in inches based on the height from the top of the T1 vertebra to the bottom of the sacrum (“Height from T1 to bottom of sacrum”). As this length goes up from 23 to 33 inches by 0.5-inch increments, the gaps 14/16 can increase by the amount shown in the corresponding columns labeled “First Gap” 14 and “Second Gap” 16, respectively. For example, when the height from the top of the T1 vertebra to the bottom of the sacrum is 23″ or less, the FSU 10 and the PSU 12 are adjacent to the CSU 11 such that no first or second gap 14/16 exists. It is generally preferred that when the height from the top of the T1 vertebra to the bottom of the sacrum is between 23 to 25 inches, the first gap 14 is between 0 to 0.5 inches and the second gap 16 is between 2 to 2.5 times greater than the length of the first gap 14, including 0″ such as if the first gap 14 does not exist at 0 inches. It is generally preferred that when the height from the top of the T1 vertebra to the bottom of the sacrum is between 25 to 27 inches, the first gap 14 is between 0.5 to 1 inches and the second gap 16 is between 2 to 2.5 times greater than the length of the first gap 14. Similarly, it is preferred that when the height from the top of the T1 vertebra to the bottom of the sacrum is between 27 to 29 inches, the first gap 14 is between 1 to 1.5 inches and the second gap 16 is between 2 to 2.5 times greater than the length of the first gap 14. It is further preferred that when the height from the top of the T1 vertebra to the bottom of the sacrum is between 29 to 31 inches, the first gap 14 is between 1.5 to 2 inches and the second gap 16 is between 2 to 2.5 times greater than the length of the first gap 14. Further it is preferred that when the height from the top of the T1 vertebra to the bottom of the sacrum is between 31″ to 33″, the first gap 14 is between 2 to 2.5 inches and the second gap 16 is between 2 to 2.5 times greater than the length of the first gap 14.

The values provided in Table 1 are merely preferred values and similar measurements can be used to achieve similar configurations or ratios between values. Devices 20 accommodating people having smaller or larger spans from the top of the T1 vertebra to the bottom of the sacrum are also expressly provided herein. For example, devices for children, having this span under 23″, such as between 16″-23″, and for tall people having this span over 33″, such as 33-38″, are also envisioned herein. According to preferred embodiments, the devices 20 herein are configured to only be used for adults or those having a height measured from the top of the T1 vertebra to the bottom of the sacrum at 23″ or higher. Devices configured for users with this span under 23″ and over 33″ can have adjustable gaps with distances and/or ratios similar to those disclosed herein, including Table 1.

In addition to measuring the span from top of the T1 vertebra to the bottom of the sacrum, other predetermined spans are readily envisioned herein including the bottom of the C7 vertebra, the bottom of the T1 vertebra, or the top/bottom of the T2 vertebra to the bottom or top of the sacrum, for example. The difference in length between the top of the T1 vertebra and another upper marker position (e.g., bottom of the C7 vertebra, the bottom of the T1 vertebra or top/bottom of T2 vertebra) can readily be determined and the values in Table 1 can be adjusted accordingly. Likewise, the difference in length between the bottom of the sacrum and another lower marker position (e.g., top of sacrum) can readily be determined and the values in Table 1 can be adjusted accordingly. For example, if the upper marker position is 0.25 inches above the top of the T1 vertebra (e.g., the bottom of the C7 vertebra) and the lower marker position is 0.25 inches below the bottom of the sacrum, the values of the height column in Table 1 could be increased by 0.5 inch for each row, while the remaining values in the other columns would remain the same. Similarly, if the upper marker position is 0.25 inches above the top of the T1 vertebra (e.g., the bottom of the C7 vertebra) and the lower marker position is 0.25 inches above the bottom of the sacrum, the height column in Table 1 would remain the same, as would the remaining values in the other columns.

When using intermittent locking points 5, each point preferably corresponds to a predetermined setting (e.g., first column of Table 1), which in turn corresponds to distances in the gaps 14/16 (and ratios between the gaps) and the measurement of a designated span on the user. According to preferred embodiments, the device 20 non-exclusively includes 21 locking points, or 1-10, or 1-15, or 1-20, or 1-25 locking points. While Table 1 increases in 0.5-inch increments, devices increasing in other increments, e.g., 1 inch, 1.5 inch, or .25 inch increments are also envisioned herein. The Table 1 values can readily be calculated and adjusted according to these different increments. For example, if 1-inch increments are used in the “Height” column instead of 0.5 inches as currently shown, only every other row of values can be used, and the “Settings” column only increases by 0.5 inch.

For the third embodiment of accommodating individualized users by providing a plurality of different sized non-adjustable devices 20, where the support units (10, 11, 12) are not slidable along the longitudinal axis on the base 7, the chart can be used to select one of a plurality of spinal support devices 20. For example, two or more fixed devices 20 can be created for two or more of the 21 rows (or other dimensions and gaps) and the user's device can be selected from these two or more devices based on the measurement of the designated spinal span, such as the top of the T1 vertebra to the bottom of the sacrum. All variations described above for adjustable devices can be utilized with the plurality of fixed devices, including different spinal spans for measurements, spinal spans from the top of the T1 vertebra to the bottom of the sacrum that are shorter than 23″ and longer than 33″, and the ratios between the first and second gaps 14/16.

According to additional embodiments (not shown) motorized massage balls can be made to travel on a contoured fixed or guided track that follows the convex body curves. Optionally, massage balls can be positioned within tracks on the convex shaped topsides 2a/2b and/or 3a/3b where they can roll on the tracks like ball bearings to increase blood flow. Further embodiments, not shown, can include a vibrating motor incorporated into the device 20 to improve blood circulation or loosen muscles, whether coupled with one or more of the support units (10, 11, 12) and/or the base 7. Further preferred embodiments include coupling exercise equipment to the device 20. Non-exclusive options include ropes, rubber or elastic bands, bars, cages, and devices that can press the person against the device 20, or allow them to lift weights, or perform strengthening or stretching movements. It is further preferred that the pressure is applied to the user by means of weights on their backside, and/or a therapist or a helper. This pressure can be preferably applied to the back of thigh area (preferably upper thighs) and mid or upper back area such as between T11 and L3 vertebrae.

Preferred methods involve a user taking a measurement of a predetermined span of the human's spine that corresponded to predetermined configurations in a spinal support device 20. The spinal device 20 can then be adjusted or otherwise selected accordingly and optionally further adjusted based on additional measurements or user characteristics such as abnormal curvatures, abnormal discs, current time of day, etc. The user can then lie on their customized device 20 in a prone position for any suitable period of time, such as between 5 and 60 minutes while their inflection points 9 on the support units (11, 12) align on the transverse plane with their respective transition points. Furthermore, the apexes 6 of the CSU and PSU support units (11 and 12) can align on the transverse plane with the centers of the corresponding concave sections of the user's frontside. Alternatively, the apex 6 of PSU 12b aligns on the transverse plane with the disc between the L5-S1, or within 0.5 inches up or down thereof. The user can remain still lying prone on the device or move such as to perform strengthening or stretching exercises. According to preferred methods of use, a separate support, detached from the devices 20 provided herein, can be used to support below the kneecaps (upper portion of tibia) or below the tibial tuberosity. This could be a cylindrical device, such as a roller, wherein the convex form of the roller aligns with the frontside below the kneecaps.

TABLE 1

| | | | Height from T1 to |
|---|---|---|---|
| | First Gap | Second Gap | bottom of sacrum |
| Setting | (inches) | (inches) | (inches) |
| 0 | 0 | 0 | 23 |
| .25 | .125 | .28 | 23.5 |
| .5 | .25 | .625 | 24 |
| .75 | .375 | .84 | 24.5 |
| 1 | .5 | 1.125 | 25 |
| 1.25 | .625 | 1.4 | 25.5 |
| 1.5 | .75 | 1.875 | 26 |
| 1.75 | .875 | 1.97 | 26.5 |
| 2 | 1 | 2.25 | 27 |
| 2.25 | 1.125 | 2.53 | 27.5 |
| 2.5 | 1.25 | 2.8 | 28 |
| 2.75 | 1.375 | 3.1 | 28.5 |
| 3 | 1.5 | 3.375 | 29 |
| 3.25 | 1.625 | 3.65 | 29.5 |
| 3.5 | 1.75 | 3.93 | 30 |
| 3.75 | 1.875 | 4.21 | 30.5 |
| 4 | 2 | 4.5 | 31 |
| 4.25 | 2.125 | 4.78 | 31.5 |
| 4.5 | 2.25 | 5.06 | 32 |
| 4.75 | 2.375 | 5.34 | 32.5 |
| 5 | 2.5 | 5.625 | 33 |

1. A method of using a spinal support device on a person:
providing a spinal support device comprising a base unit having a longitudinal axis along first and second ends, and having a face support unit defining the first end, a pelvic support unit defining the second end, and a chest support unit positioned between said face and pelvic support units, wherein the pelvic and chest support units each have a convex shaped topside with an apex; and
positioning the person on the device in a prone position, wherein the face of the person is positioned on the face support unit, the apex of the chest support unit supports the center, or within 0.5 inches up or down therefrom, of the disc between the T6 and T7 vertebrae, and the apex of the pelvic support unit supports a position on the spine at point between the L5 vertebra to 1 inch down from the top of the sacrum.

2. The method of claim 1, wherein the face support unit is configured to be slidable and releasably lockable along the longitudinal axis of the base unit both towards and away from the chest support unit so as to form a first gap from the face support unit and the chest support unit; and wherein the pelvic support unit is configured to be slidable and releasably lockable along the longitudinal axis of the base unit both towards and away from the chest support unit so as to form a second gap between the pelvic support unit and the chest support unit

3. The method of claim 2, further comprising measuring the length of a predetermined span of the human's spine and adjusting the face and pelvic support units either closer to or away from the chest support unit based on the measured length, wherein, for a first person having a longer measurement than a second person, the face and pelvic support units are moved away from the chest support unit for the first person and moved closer to the chest support unit for the second person.

4. The method of claim 3, wherein when the pelvic support and the face supports are moved away from the chest support and releasably locked, the second gap between the pelvic support unit and the chest support unit is longer in length than the first gap between the face support unit and the chest support unit.

5. The method of claim 4, wherein the length of the second gap is between 2.0 to 2.5 times greater than the length of the first gap.

6. The method of claim 5, wherein the length of the second gap is 2.25 times greater than the length of the first gap.

7. The method of claim 3, wherein intermittent locking points are set between: a) the face support unit and chest support unit, and b) the pelvic support unit and the chest support unit, such that the face and pelvic support units are releasably lockable at these points along the longitudinal axis and correspond to preset measured lengths of the predetermined span of the human's spine.

8. The method of claim 7, wherein the predetermined span of the human's spine that is measured is the distance from the top of the T1 vertebra to the bottom of the sacrum.

9. The method of claim 8, wherein the predetermined span is measured by having the user sit upright on a surface and measuring the distance from the T1 vertebra and the surface.

10. The method of claim 8, wherein when the predetermined length of the human spine is 23″ or less, the neck and upper thigh support units are adjacent to the mid-back support such that no first or second gaps exists.

11. The method of claim 10, wherein when the length of the human spine is between 23″ to 25″, the first gap is between 0 to 0.5 inches and the second gap is between 2.0 to 2.5 times greater than the length of the first gap.

12. The method of claim 11, wherein when the length of the human spine is between 25″ to 27″, the first gap is between 0.5 to 1 inches and the second gap is between 2.0 to 2.5 times greater than the length of the first gap.

13. The method of claim 12, wherein when the length of the human spine is between 27″ to 29″, the first gap is between 1 to 1.5 inches and the second gap is between 2.0 to 2.5 times greater than the length of the first gap.

14. The method of claim 13, wherein when the length of the human spine is between 29″ to 31″, the first gap is between 1.5 to 2 inches and the second gap is between 2.0 to 2.5 times greater than the length of the first gap.

15. The method of claim 14, wherein when the length of the human spine is between 31″ to 33″, the first gap is between 2 to 2.5 inches and the second gap is between 2.0 to 2.5 times greater than the length of the first gap.

16. The method of claim 1, wherein the face, pelvic, and chest support units are not slidable along the longitudinal axis on the base, such that they are fixed in place.

17. The method of claim 16, further comprising measuring the length of a predetermined span of the human's spine and selecting the spinal support device from first and second spinal support devices based on said measurement, wherein the first and second spinal support devices have differently sized fixed distances between the chest support unit and the face and pelvic support unit from each other.

18. The method of claim 1, wherein the convex shaped topside of the pelvic support unit comprises two convex shaped topsides that converge towards the second end at an angle from 30-60 degrees.

19. The method of claim 18, wherein the chest support unit comprises two shoulder rests that support the persons shoulders while lying prone on the device.

20. The method of claim 19, wherein the converging convex shaped topsides and/or the shoulder rests are adjustable such that the angle of the converging convex shaped topsides or the distance between the shoulder rests can be increased or decreased.
